(19) United States
(12) Patent Application Publication
(10) Pub. No.: US 2005/0274741 A1
(43) Pub. Date: Dec. 15, 2005

(54) Cap for a bottle

(76) Inventor: Young Kook Cho, Huntington Park, CA (US)

Correspondence Address: Jerry H. Noh, Suite 2741, 3435 Wilshire Blvd, Los Angeles, CA, 90010, US

(21) Appl. No.: 11/146,776

(22) Filed: Jun. 6, 2005

(30) Foreign Application Priority Data
Jun. 7, 2004 (KR) 2004-0041545

(51) Int. Cl. B65D 55/16; B67D 5/32

(52) U.S. Cl. 222/153.14; 215/306; 220/375; 222/543

(57) ABSTRACT

Disclosed herein is a cap for a bottle which has a first cap member, a spouted second cap member rotatably connecting to the first cap member, and a protective cover configured such that the protective cover can be easily separated from the spouted second cap member of the bottle cap, and can be hygienically kept when the protective cover is separated from the spouted second cap member, thus being easily used. The cap including a protective cover to cover and protect the spout of the second cap member of the cap, and the protective cover having a grooved rim around a lower end thereof to engage with a locking rim of the spouted second cap member. A band connecting the protective cover with an arm member connected to the bottle, so that, when the second cap member is rotated and moved upwards, the coupling means is tensioned, thus opening the protective cover from the spouted second cap member and exposing the spout of the second cap member to the atmosphere while the opened protective cover maintains its coupled state relative to the bottle.

### BACKGROUND OF THE INVENTION

1. Field of the Invention

The present invention relates generally to bottle caps, such as sports caps, and, more particularly, to a protective bottle cap which has a protective cover configured such that the protective cover can be easily separated from a spouted second cap member of the bottle cap, and can be hygienically kept when the protective cover is separated from the spouted second cap member, thus being easily used by a user.

2. Description of the Related Art

Generally, conventional caps for a bottle, for example, conventional sports caps, each have a structure in which a protective cover is provided to engage with a spouted cap member to cover the spout of the cap member. The protective cover is configured as a separate member, so that, when the protective cover is removed from the cap member of the bottle, so that the user can actuate the cap member and to open the cap member and, thereafter, to drink from bottle via the spout, the protective cover cannot maintain its coupled state relative to the bottle, but is completely removed from the bottle. Thus, when the protective cover is separated from the spouted cap member, a user must carefully manage the separated protective cover to prevent the cover from being lost or contaminated. Furthermore, the protective cover of the conventional protective bottle cap does not have a locking support means for maintaining the coupled state of the protective cover relative to the cap member while the cover is separated from the cap member. Thus, the conventional bottle cap inconveniences a user.

### SUMMARY OF THE INVENTION

Accordingly, the present invention has been made keeping in mind the above problems occurring in the prior art, and an object of the present invention is to provide a cap for a bottle which has a protective cover configured such that the cover can be easily separated from a cap member of the bottle cap, and can be hygienically kept when the cover is removed from the cap member, thus being easily and hygienically used by a user.

In order to accomplish the above object, the present invention provides a cover for a cap. The cap has a first cap member and a second cap member rotatably connected to the first cap member. The second cap member has a spout. The cap comprises a protective cover to cover and protect the spout of a second cap member, wherein the protective cover has a grooved rim around a lower end thereof to engage with a locking rim of the spouted second cap member, and is coupled to a neck of a bottle body by coupling means, so that, when the second cap member is rotated and moved upwards, the coupling means is tensioned, thus opening the protective cover from the spouted second cap member and exposing the spout of the second cap member to the atmosphere while the opened protective cover maintains its coupled state relative to the bottle.

In the cap of the present invention, the coupling means may comprise: a band extending downwards from the protective cover; and an arm member to couple the band to the neck of the bottle body, the arm member can be integrally formed with a lower end of the band or can have a mounting hole to be coupled to the lower end of the band, and the grooved rim of the protective cover comprises two locking rings, with a plurality of opening slits formed on a lower part of the two locking rings, so that the protective cover is easily separated from the second cap member, with a finger holder being formed on a part of a top edge of the protective cover so that the protective cover may be opened by a user's finger which levers the finger holder upwards.

The cap of the present invention may further comprise: an opening protrusion provided on a predetermined position of a lower part of the protective cover; an actuating protrusion provided on an upper surface of the spouted second cap member at a position corresponding to the opening protrusion so that the actuating protrusion pushes the opening protrusion when the second cap member is rotated and moved upwards.

In the cap of the present invention, the spouted second cap member may further comprise an actuating protrusion vertically extending upwards from an upper surface of the second cap member, so that the actuating protrusion pushes and opens the protective cover when the second cap member is rotated and moved upwards.

In the cap of the present invention, the coupling means may comprise: a band extending downwards from the protective cover; an arc-shaped arm member and a support block integrated with each other, the support block being integrally formed with a lower end of the band or having a mounting hole to be coupled to the lower end of the band, the arc-shaped arm member having two ends provided with a support ratchet on each of upper and inner surfaces of each end, so that the arc-shaped arm is inserted into and engages with a ratchet groove of the bottle body, but is not removed from the ratchet groove.

The coupling means may also comprise: a band extending downwards from the protective cover, a band support provided on the bottle body, with a band ratchet formed along a lower surface of the band support such that the band ratchet has a pitch equal to that of an upper ratchet provided on the arm member of the coupling means, and a mounting hole vertically formed through a predetermined position of the band support and coupled to a lower end of the band.

In the alternative, the coupling means may comprises: a support block which projects outwards from a part of a side surface of the first cap member, with a mounting hole vertically formed through a predetermined position of the support block; and a band which extends downwards from the protective cover and passes through the mounting hole of the support block, and is locked to the support block by a locking end.

### BRIEF DESCRIPTION OF THE DRAWINGS

The above and other objects, features and advantages of the present invention will be more clearly understood from the following detailed description taken in conjunction with the accompanying drawings, in which:

FIG. 1A is a perspective view illustrating the construction of a cap according to a first embodiment of the present invention;

FIG. 1B is an enlarged view of area 1B of FIG. 1A illustrating a thrusting structure provided in the junction between a protective cover and a spouted second cap member of the protective bottle cap according to the first embodiment of the present invention;

FIG. 1C is an isolated perspective view of the arm member and a portion of the band of the cap according to the first embodiment of the present invention;

FIG. 2 is a sectional view illustrating the protective cover fitted over the spouted second cap member of the protective bottle cap according to the first embodiment of the present invention;

FIG. 3 is a sectional view illustrating the protective cover shown as it is being pulled during operation of the cap according to the first embodiment of the present invention;

FIG. 4 is a sectional view illustrating the protective cover fully opened during the operation of the cap according to the first embodiment of the present invention;

FIG. 5 is a bottom view of an isolated protective cover illustrating the shape of the protective cover of the cap according to the first embodiment of the present invention;

FIG. 6 is a perspective view illustrating the construction of a protective bottle cap according to a modification of the first embodiment of the present invention;

FIG. 7 is a perspective view illustrating the construction of a protective bottle cap according to a second embodiment of the present invention;

FIG. 8 is a sectional view illustrating a protective cover fitted over a spouted second cap member of the protective bottle cap according to an alternative embodiment of the second embodiment of the present invention; and

FIG. 9 is a sectional view illustrating the protected cover fully opened during the operation of the protective bottle cap according to the alternative embodiment of the second embodiment of the present invention.

### DESCRIPTION OF THE PREFERRED EMBODIMENTS

Reference now should be made to the drawings, in which the same reference numerals are used throughout the different drawings to designate the same or similar components.

### First Embodiment

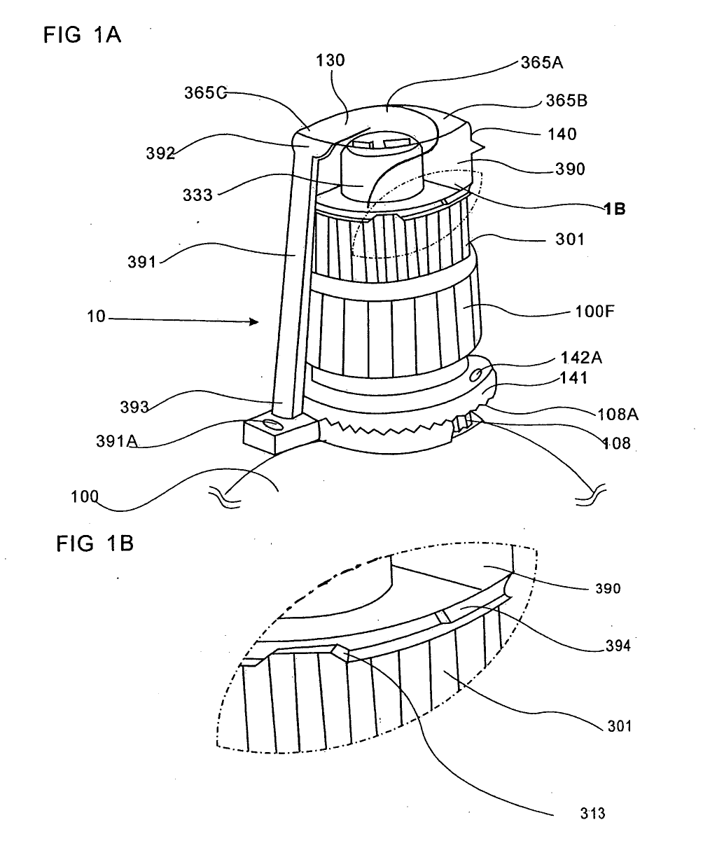

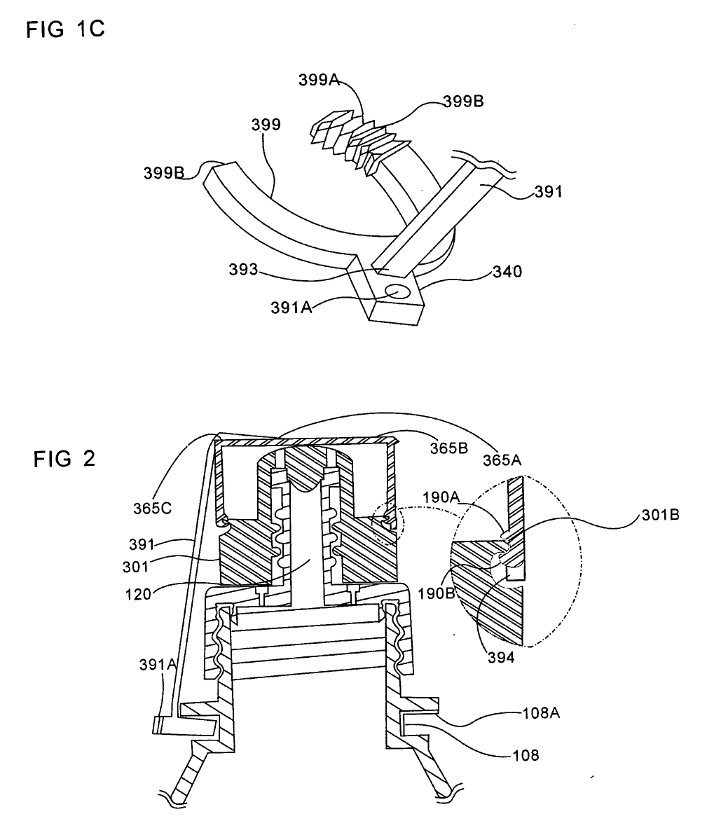

FIG. 1A is a perspective view illustrating the construction of a cap 10 for a bottle according to a first embodiment of the present invention. The cap 10 has a first cap member 100F and a second cap member 301 rotatably connected above the first cap member 100F. The second cap member 301 has a spout 333. The first cap member 100F is connected to the bottle 100 FIG. 1B is an enlarged perspective view of the 1B area of FIG. 1A illustrating a thrusting structure provided in the junction between a protective cover 390 and a second cap member 301 of the cap 10 according to the first embodiment of the present invention.

As shown in FIG. 1C that illustrates an arm member 399 of the cap 10 according to the first embodiment, the arm member 399 is configured to be arch-shaped in appearance so that the arm member 399 can be inserted into a ratchet groove that is formed around the neck of a bottle 100, with a side ratchet 108 formed around an inner surface of the groove. The bottle 100 is preferably made of PET (polyethylene terephthalate). In the above case, at least half of the arc-shaped arm member 399 is inserted into the ratchet groove. Thus, the arm member 399 can securely maintain its engaging state within the groove without being easily removed from the groove, although a user carries the capped bottle by holding a protective band 391. The arm member 399 has two ends 399B, and each end 399B is provided with a support ratchet 399A along each of the upper and inner surfaces thereof, so that the arm member 399 can be easily inserted into and engage with the ratchet groove of the bottle 100, but cannot be easily removed from the groove. A band ratchet 108A is formed along the lower surface of a band support 141 and engages with the ratchet 399A of the arm member 399, so that the arm member 399 can advance in a direction within the ratchet groove, but is not removed from the ratchet groove. When the arm member 399 is inserted into the ratchet groove, the support ratchet 399A made of PP (polypropylene) movably engages with both the PET band ratchet 108A and the PET side ratchet 108 of the bottle 100 while generating light click sounds caused by the difference of material between the ratchets 399A, 108A and 108. Thus, market competitiveness of the caps according to the first embodiment is increased.

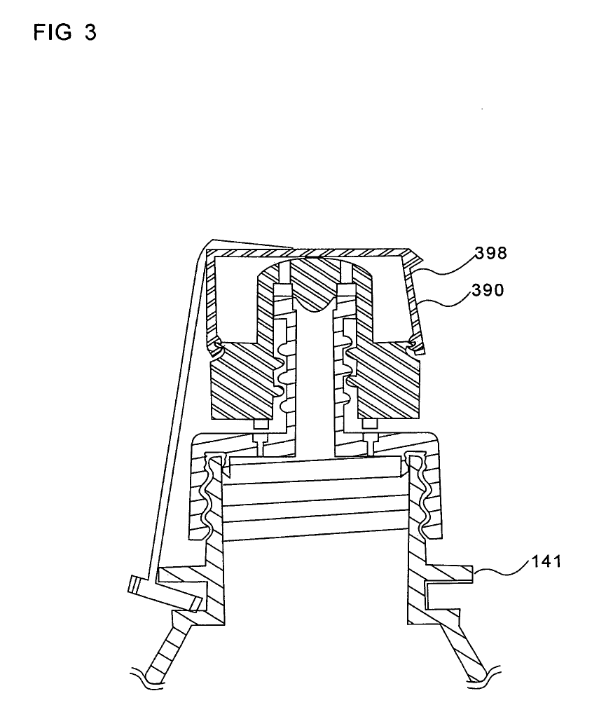

The band 391, which longitudinally extends at a second end 393 upwards from a support block 340 of the arm member 399, has a thin strap shape so that the band 391 can be easily bent forwards or backwards but cannot be bent to the left or right. The protective cover has a back area 390A and an opposed front area 140. The band 391 has a first end 392 which is integrally coupled to a thick part 365A of the top wall of the protective cover 390 at the back area 130 by a strong junction 365C, so that, although a second cap member 301 of the cap is rotated and moved upwards, the band 391 can maintain its straightened state relative to the arm member 399 without being shrunk or twisted. As shown in FIG. 1B, during a rotation of the second cap member 301, the protective band 391 is tensioned more and more (shown in FIG. 3) and an actuating protrusion 313 of the second cap member 301 comes into contact with and pushes a protrusion 394 of the protective cover 390. Thus, a thin part 365B of the top wall of the protective cover 390 is pushed upwards, so that the protective cover 390 is opened. In the above case, the protective cover 390 has been locked to the second cap member 301 by a grooved rim of the protective cover 390, whose groove is defined between two locking rings 190A and engages with a locking rim 301B of the second cap member 301. Furthermore, a lower part of the two locking rings 190A has a plurality of horizontal opening slits 190B around the front area 140 of the protective cover 390, so that the protective cover 390 can be easily separated from the second cap member 301. Alternatively, a finger holder 398 may be formed on a part of the top edge of the protective cover 390 so that the protective cover 390 can be opened by a user's finger which levers the finger holder 398 upwards.

FIG. 2 is a sectional view illustrating the protective cover fitted over the spouted second cap member of the cap according to the first embodiment of the present invention. As shown in this figure, the first cap member 100F has defined therein a discharge path 120 for the discharge of miscellaneous material(s) contained in the bottle 100. The spout 333 of the second cap member 301 is formed and positioned for covering and uncovering the discharge path 120 of the first cap member 100F.

FIG. 3 is a sectional view illustrating the protective cover which is pulled during operation of the cap. As shown in the drawings, when the second cap member 301 having a spout 333 is rotated and moved upwards, the band 391 coupled to the band support 141 is tensioned and, thereafter, the protective cover 390 is forcibly pulled downwards to a side based on the strong junction 365C. In the above case, the grooved rim of the protective cover 390, which has the opening slits 190B along the lower locking ring 190A and engages with the locking rim 301B of the second cap member 301, can be easily separated from locking rim 301B of the second cap member 301. Thus, the protective cover 390 can be easily removed from the spouted second cap member 301.

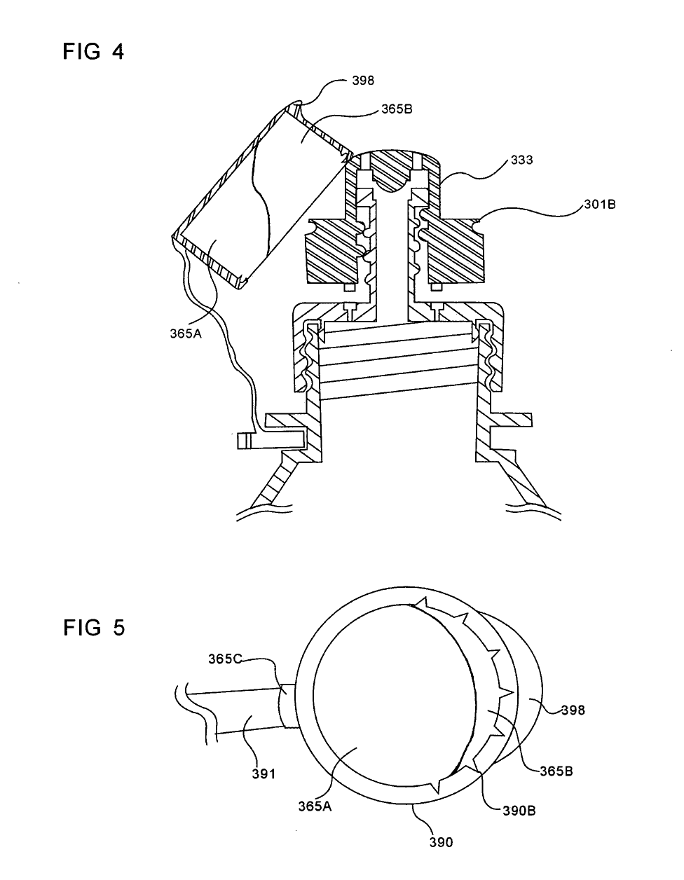

FIG. 4 is a sectional view illustrating the protective cover 390 fully opened during the operation of the cap according to the first embodiment of the present invention. As shown in the drawing, the protective cap 390 is removed from the second cap member 301, so that the tensioned band 391 is released. FIG. 5 is a bottom view of an isolated protective cover 390 illustrating the shape of the protective cover 390 of the cap according to the first embodiment of the present invention.

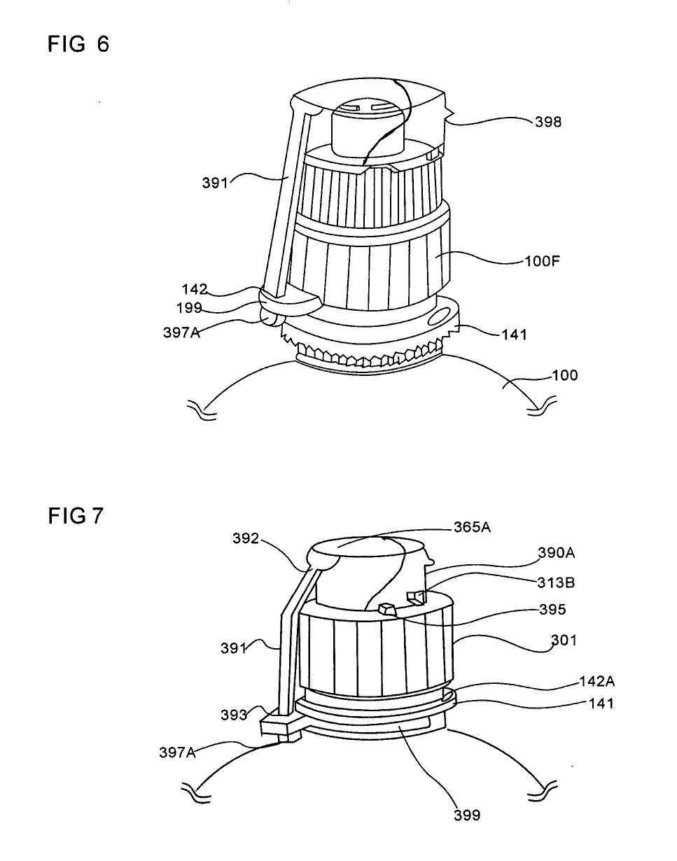

FIG. 6 is a perspective view illustrating the construction of a cap according to a modification of the first embodiment of the present invention. As shown in FIG. 6, a support block 199 having a mounting hole 142 integrally projects outwards from a part of the side surface of the first cap member body 100F in a radial direction, while a band 391 extends downwards from the protective cover and passes through the mounting hole 142, and is locked to the support block 199 by a locking end 397A at the second end 393. This modification does not have arm member 399.

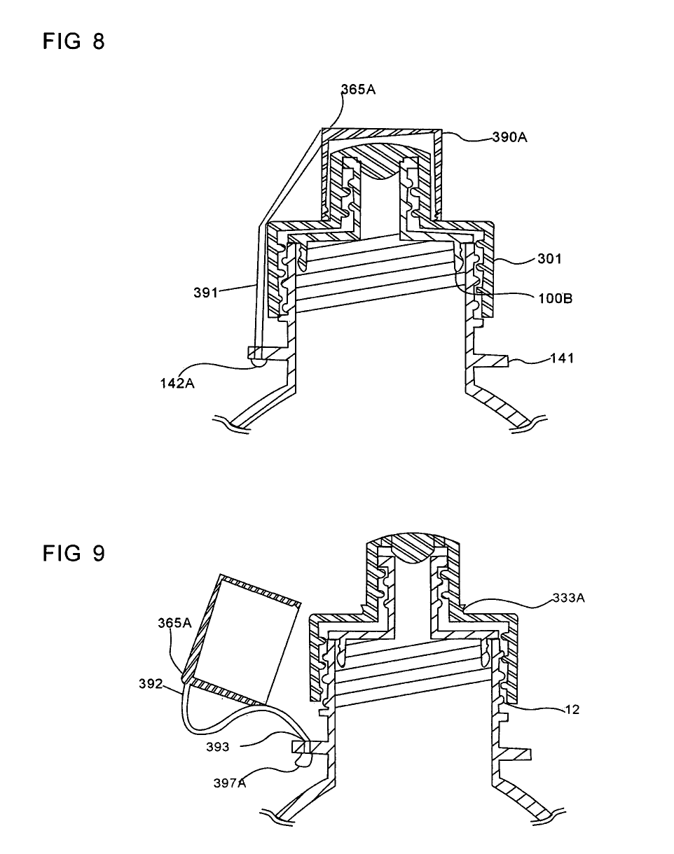

FIGS. 7, 8 and 9 shows a construction of a protective bottle cap according to a second embodiment of the present invention. As shown in FIG. 7, an opening protrusion 313B is provided on a predetermined position of a lower part of a protective cover 390A, while an actuating protrusion 395 is provided on a predetermined position of the upper surface of an second cap member 301 such that the actuating protrusion 395 pushes the opening protrusion 313B when the second cap member 301 is rotated and moved upwards. The cap according to the second embodiment has a shape similar to that of a conventional sports cap. The second cap member 301 is tightened to the outer thread 12 of the mouth of a bottle such that the second cap member 301 covers the first cap member 100F. The first cap member 100F has an inside lid 100B that extends into the mouth of the bottle 100. Thus, a bottled material can be easily discharged to the outside of the bottle 100 by operation of the second cap member 301. Furthermore, the protective cover 390A can be easily actuated and managed by operation of the second cap member 301. When the second cap member 301 of the cap according to the second embodiment is loosened from the outer thread 12 of the bottle mouth and is moved upwards in the same manner as that of a conventional bottle cap, the second cap member 301 accomplishes the two functions of discharging the bottled material to the outside and of easily actuating and managing the protective cover 390. The second embodiment of the cap also has a band 391 having a first end 392 which is integrally coupled to a thick part 365A of the top wall of the protective cover 390A. The second end 393 of the band 391 in this embodiment can either be attached to an arm member 399 attached to the bottle 100 as shown in FIG. 7, or in the alternative as shown in FIGS. 8 and 9, the second end 39 of the band can be connected to a band support 141 formed on a neck of the bottle 100 by passing through a mounting hole 142A vertically formed through the band support 141 and being held there by a locking end 397A of the second end 393.

FIG. 8 is a sectional view illustrating a tightened state of the cap according to the second embodiment of the present invention. FIG. 9 is a sectional view illustrating the operation of the cap according to the second embodiment of the present invention. Furthermore, as shown in FIG. 9, the protective cover 390A is separated from a locking thread 333A of the second cap member 301 when the second cap member 301 is rotated and moved upwards. In other words, while the second cap member 301 is rotated and moved upwards, the band 391, is tensioned more and more, so that the protective cover 390A is separated from the locking thread 333A of the second cap member 301. The mounting hole 142A can be easily formed on a conventional PET bottle without requiring a conventional bottle production process to be largely changed.

Thus, while the band 391 is tensioned as described above, a user pushes the opening protrusion 313B of the protective cover 390A using the actuating protrusion 395 of the second cap member 301 by simply rotating the second cap member 301 without fearing about loss or special management of the protective cover 390A. Thus, the protective cover 390A can be easily removed from the second cap member 301 prior to drinking a bottle material contained in the bottle 100.

As described above, the present invention provides a cap which has a protective cover configured such that the protective cover can be easily separated from a spouted second cap member of the cap, and can be hygienically kept when the protective cover is separated from the spouted second cap member and opens the spout of the second cap member. Thus, the cap is easily used by a user.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A cap for a bottle, said cap comprising:
a first cap member connecting to said bottle;
a second cap member rotatably disposed over said first cap member, said second cap member having a spout;
a removeable protective cover covering said spout of said second cap member, said protective cover having a back area and an opposed front area;
a band connected at a first end to said back area of said-protective cover and at a second end to said bottle; and,
wherein the protective cover and band is arranged and formed so that, when the second cap member is rotated to move upwards, the band is tensioned to remove the protective cover from the second cap member.

2. A cap as described in claim 1 wherein the second cap member has a locking rim extending around a portion thereof, and wherein the protective cover has a grooved rim extending around a lower end thereof to engage with said locking rim of the second cap member.

3. The cap as described in claim 2 further comprising a plurality of horizontal slits formed at the lower end of the protective cover around the front area of the protective cover.

4. The cap as set forth in claim 1, further comprising:
an opening protrusion provided on a predetermined position of a lower part of the protective cover;
an actuating protrusion provided on an upper surface of the second cap member at a position corresponding to the opening protrusion so that the actuating protrusion pushes the opening protrusion when the second cap member is rotated and moved upwards.

5. A cap for a bottle, said bottle having a neck, said cap comprising:
a first cap member connecting to said bottle;
a second cap member rotatably disposed over said first cap member, said second cap member having a spout;
a removeable protective cover covering said spout of said second cap member, said protective cover having a back area and an opposed front area;
an arm member connecting to said neck of said bottle below said first cap member and second cap member;
a band connected at a first end to said back area of said protective cover and at a second end to said arm member; and,
wherein the protective cover and band is arranged and formed so that, when the second cap member is rotated to move upwards, the band is tensioned to remove the protective cover from the second cap member.

6. A cap as described in claim 5 wherein the second cap member has a locking rim extending around a portion thereof, and wherein the protective cover has a grooved rim extending around a lower end thereof to engage with said locking rim of the second cap member.

7. The cap as described in claim 6 further comprising a plurality of horizontal slits formed at the lower end of the protective cover around the front area of the protective cover.

8. The cap as set forth in claim 5, further comprising:
an opening protrusion provided on a predetermined position of a lower part of the protective cover;
an actuating protrusion provided on an upper surface of the second cap member at a position corresponding to the opening protrusion so that the actuating protrusion pushes the opening protrusion when the second cap member is rotated and moved upwards.

9. The cap as described in claim 5 wherein the arm member is in the shape of an arc having two ends, each ends of the arm member having a support ratchet on each of the upper and inner surfaces thereof, so that the arm member is inserted into and engages with a ratchet groove formed on the bottle, but is not removed from the ratchet groove.

10. A cap for a bottle, said cap comprising:
a first cap member connecting to said bottle;
a second cap member rotatably disposed over said first cap member, said second cap member having a spout;
a locking rim extending around a portion of said second cap member;
a removeable protective cover covering said spout of said second cap member, said protective cover having a back area and an opposed front area;
a grooved rim extending around a lower end of the protective cover to engage with said locking rim of the second cap member;
a band connected at a first end to said back area of said protective cover and at a second end to said first cap member member; and,
wherein the protective cover and band is arranged and formed so that, when the second cap member is rotated to move upwards, the band is tensioned to remove the protective cover from the second cap member.

11. The cap as described in claim 10, further comprising:
a protrusion provided on a predetermined position of a lower part of the protective cover;
an actuating protrusion provided on an upper surface of the second cap member at a position corresponding to the opening protrusion so that the actuating protrusion pushes the protrusion of the protective cover when the second cap member is rotated and moved upwards.

12. The cap as described in claim 10 further comprising a plurality of horizontal slits formed at the lower end of the protective cover around the front area of the protective cover.
